(19) United States
(12) Patent Application Publication
(10) Pub. No.: US 2019/0200412 A1
(43) Pub. Date: Jun. 27, 2019

(54) METHOD AND DEVICE FOR MANAGING RADIO AND PHYSICAL INTERFACES OF A COMMUNICATING APPARATUS

(71) Applicant: SAGEMCOM BROADBAND SAS, RUEIL MALMAISON (FR)

(72) Inventors: Serge CONTAL, RUEIL MALMAISON (FR); Alexis GRAUL, RUEIL MALMAISON (FR); Laurent TRICAUD, RUEIL MALMAISON (FR)

(21) Appl. No.: 16/330,488

(22) PCT Filed: Aug. 31, 2017
(86) PCT No.: PCT/EP2017/071916

§ 371 Date: Mar. 5, 2019

(30) Foreign Application Priority Data
Sep. 5, 2016 (FR) 1658224

(51) Int. Cl. H04W 76/23; H04B 15/02; H04B 1/10; H04W 16/14; H04W 28/02; H04W 36/30

(52) U.S. Cl. CPC H04W 76/23; H04B 15/02; H04W 36/30; H04W 16/14; H04W 28/0236; H04B 1/1027

(57) ABSTRACT

A management device equips a communicating apparatus including at least one radio interface and at least one physical interface. This device includes its own analyzing system, in the event that a peripheral is connected to the physical interface, to determine a mapping of the quality of radio communications on this radio interface, and a processor suitable for comparing this determined mapping to another mapping of the quality of radio communications on the radio interface in the absence of a peripheral connected to the physical interface, and, in the event of a deterioration in the quality of radio communications as a result of this connection, to trigger a modification of a first current operating configuration of the radio interface based on the determined mapping or a second current operating configuration of the physical interface.

The invention relates to communicating apparatuses that comprise at least one radio interface and at least one physical interface, and more specifically the management of these radio and physical interfaces.

As those skilled in the art know, when a peripheral is connected to a physical interface of a communicating apparatus also having a radio interface (for communications through waves), the operation of this peripheral can induce interferences that deteriorate the radio communications of the communicating apparatus.

In fact, the appearance of background noise spreading out over at least one part of the radio communications spectrum of the communicating apparatus may be observed, and this background noise and its spectral localisation vary according to the operating frequency of the connected peripheral. The result is a perturbation of the radio exchanges between the communicating apparatus and each other communicating apparatus to which the latter is temporarily coupled.

As a non-limiting example, when a Bluetooth peripheral, such as a wireless mouse, is coupled to a radio interface of a desktop or laptop computer, the connection of a USB 3.0 key to a USB 3.0 port of the latter can cause reactivity problems.

It has certainly been proposed to add shielding around peripherals and/or on certain components of communicating apparatuses, and notably their interfaces. But in practice this only makes it possible to attenuate slightly the propagation of ambient noise and to limit slightly perturbations on the radio communication channels. Moreover, depending on the peripherals and depending on the communicating apparatuses, the shieldings used turn out to be more or less efficient, and thus the perturbations may be more or less considerable.

The aim of the invention is thus notably to improve the situation.

It proposes notably to this end a management method, intended to enable the management of at least one radio interface and at least one physical interface of a communicating apparatus, and comprising a step in which, in the event of connection of a peripheral to the physical interface:
a mapping of the quality of radio communications on the radio interface is determined, then this determined mapping is compared with another mapping of the quality of radio communications on this radio interface in the absence of peripheral connected to this physical interface, and
in the event of deterioration of the quality of radio communications resulting from this connection, there is modification of a first current operating configuration of the radio interface as a function of the determined mapping or a second current operating configuration of the physical interface.

Thanks to this modification of the radio part (transmission/reception) of the communicating apparatus or of the physical interface part of the communicating apparatus one is less bothered, or even no longer bothered at all, by the perturbations that are induced by the connection of the peripheral to the physical interface.

The management method according to the invention may include other characteristics that may be taken separately or in combination, and notably:
the modification of the first configuration may be selected from (at least) a change of radio channel and a change of radio band;
   in its step, in the event of impossibility of changing a radio channel used, it is possible to determine if it is possible to carry out a change of a radio band used, and in the affirmative this change of radio band may be carried out;
the modification of the second configuration may be chosen from (at least) a restraint of the physical interface and a deactivation of the physical interface;
   in its step, in the presence of deterioration, of an impossibility of modifying the first configuration and of an operating priority of the radio interface, it is possible to begin by restraining the physical interface, and if this does not make it possible to improve the quality of radio communications the physical interface may be deactivated;
an operating priority of the radio interface or of the physical interface may be chosen by a user of the communicating apparatus before the connection of the peripheral to the physical interface;
before its step it is possible to determine the mapping of the quality of radio communications on the radio interface in the absence of peripheral connected to the physical interface.

The invention also proposes a computer programme product comprising a set of instructions which, when it is executed by processing means, is suitable for implementing a method of the type of that described here above for managing at least one radio interface and at least one physical interface of a communicating apparatus.

The invention also proposes a management device, intended to manage at least one radio interface and at least one physical interface of a communicating apparatus, and comprising:
analysis means suitable, in the event of connection of a peripheral to the physical interface, for determining a mapping of the quality of radio communications on the radio interface, and
processing means suitable for comparing this determined mapping with another mapping of the quality of radio communications on the radio interface in the absence of peripheral connected to the physical interface, and, in the event of deterioration of the quality of radio communications resulting from this connection, triggering a modification of a first current operating configuration of the radio interface as a function of the determined mapping or a second current operating configuration of the physical interface.

The invention also proposes a communicating apparatus comprising at least one radio interface, at least one physical interface, and a management device of the type of that described above.

Other characteristics and advantages of the invention will become clear on examining the detailed description hereafter, and the appended drawings, in which:

FIG. 1 illustrates in a schematic and functional manner an example of communicating apparatus comprising a radio interface, a physical interface and a management device according to the invention,

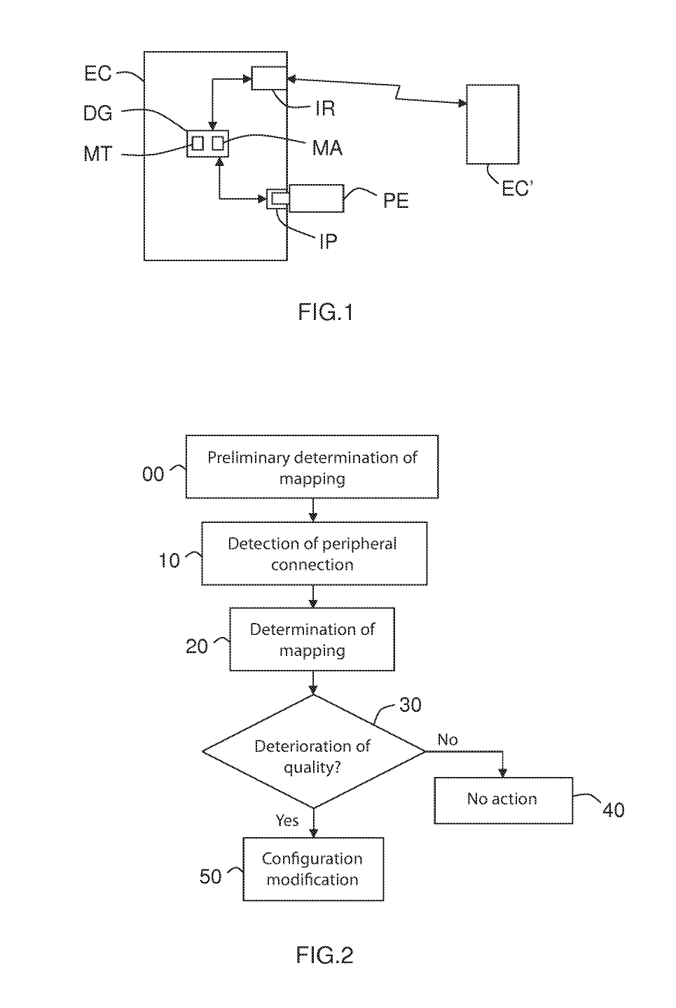

FIG. 2 illustrates an example of algorithm implementing a management method according to the invention, and

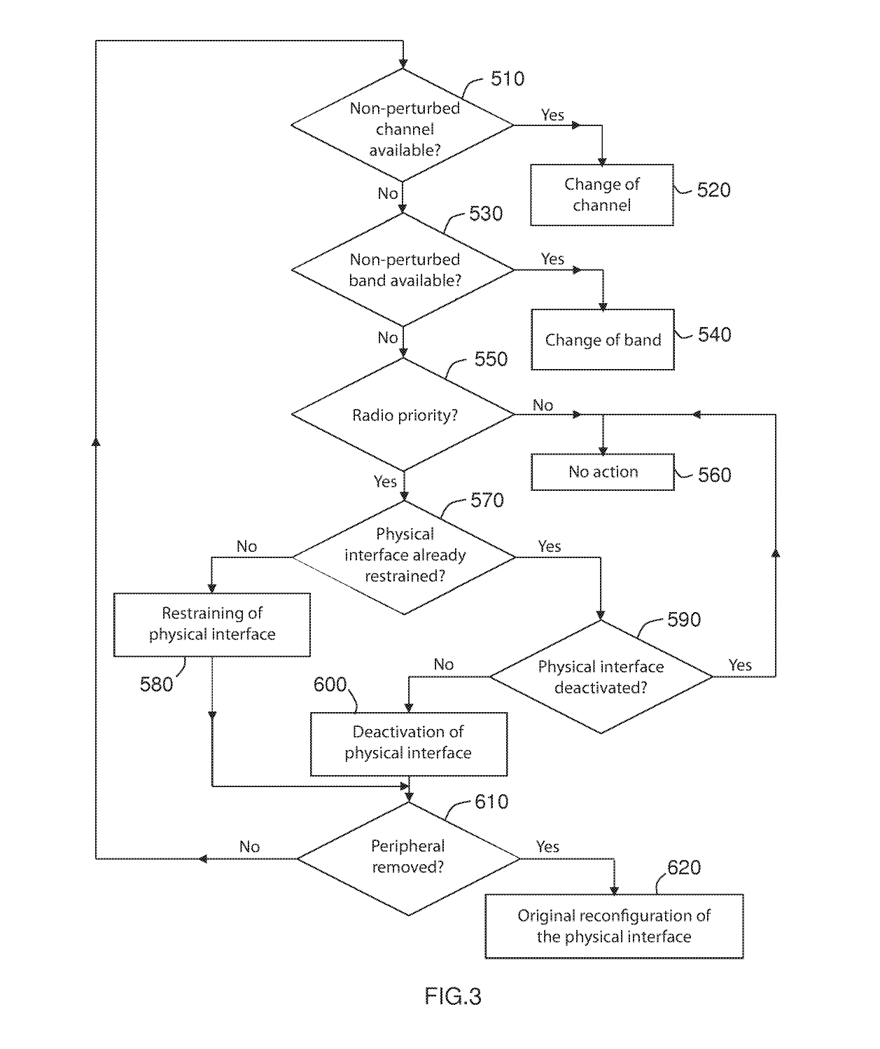

FIG. 3 illustrates an example of algorithm implementing a phase of modification of configuration of a management method according to the invention.

The aim of the invention is notably to propose a management method, and an associated management device, intended to enable the management of at least one radio interface IR and at least one physical interface IP of a communicating apparatus EC, in order to limit as much as possible the perturbations induced on the radio communications via the radio interface IR by a peripheral PE connected to a physical interface IP.

Hereafter, as a non-limiting example, it is considered that the communicating apparatus EC is a portable computer (or laptop). But the invention is not limited to this type of communicating apparatus EC. Indeed it relates to any type of communicating apparatus EC comprising at least one radio interface enabling it to communicate through waves with at least one other communicating apparatus, and at least one physical interface to which may be connected a peripheral. Consequently, it also and notably relates to desktop computers, multimedia content receivers (optionally of “Personal Video Recorder Set Top Box” (or PVR STB) type), domestic or residential type communication gateways, routers, servers, base stations, femtocells, printers, mobile telephones (optionally of smartphone type), play consoles, video projectors, cameras, photographic devices, smart TVs and test and measurement devices.

FIG. 1 schematically illustrates an exemplary embodiment of a communicating apparatus EC comprising a radio interface IR, a physical interface IP and a management device DG according to the invention. It will be noted that the communicating apparatus EC could comprise several (at least two) radio interfaces IR and/or several (at least two) physical interfaces IP.

The radio interface IR allows the communicating apparatus EC (here a laptop) to communicate through waves with at least one other communicating apparatus EC′. Said communicating apparatus (EC′) may, for example, be a wireless mouse, a multimedia content receiver (optionally of PVR STB type), a domestic or residential communication gateway, a router, a server, a base station, a femtocell, a printer, a mobile telephone, a games console, a video projector, a camera, a photographic device, a smart TV or a test and measurement device.

The physical interface IP enables the (physical) connection of a peripheral PE to the communicating apparatus EC (here a laptop). This peripheral PE may, for example, be a USB key (optionally of 3.0 type), or a wired mouse or a Sata hard disc, a PCI-E extension card, a HDMI cable, a 4G key, a wireless games controller and its associated USB adaptor.

As mentioned previously, the invention propose a management method intended to enable the management of the radio interface(s) IR and physical interface(s) IP of the communicating apparatus EC, in order to limit as much as possible perturbations induced on the radio communications with the other communicating apparatus EC′ via the radio interface IR by the peripheral PE that is connected to a physical interface IP.

Such a method may be implemented at least partially by the management device DG that equips the communicating apparatus EC and which comprises analysis means MA and processing means MT. In the non-limiting example illustrated in FIG. 1, the management device DG advantageously forms part of the communicating apparatus EC. But this is not obligatory. Indeed, and although this is not preferred, it could be connected to the communicating apparatus EC. Consequently, the management device DG may be produced in the form of software (or computer) modules, or instead a combination of electronic circuits (or hardware) and software modules.

A management method, according to the invention, comprises a step that is implemented each time that a peripheral PE is (physically) connected to the physical interface IP of the communicating apparatus EC.

In this step, one begins by determining a mapping cs1 of the quality of radio communications on the radio interface IR, then this determined mapping cs1 is compared with another mapping cs2 of the quality of radio communications on this radio interface IR in the absence of peripheral PE connected to the physical interface IP.

It will be understood that it is the analysis means MA that are arranged to determine the mapping cs1, and it is the processing means MT that are arranged to compare this determined mapping cs1 with the other mapping cs2.

Each mapping cs1, cs2 is for example representative of the background noise and/or the throughput on each band of frequencies that can be used by the communicating apparatus EC in transmission/reception, as a function of the frequency.

It will be noted that it is possible to determine, before the step of the management method, the mapping cs2 of the quality of radio communications on the radio interface IR in the absence of peripheral PE connected to the physical interface IP. To do so, the analysis means MA may use the same method as that that they use to determine the mapping cs1. But in an alternative the mapping cs2 could be predetermined by the manufacturer of the communicating apparatus EC and stored in said apparatus (EC) or in the management device DG.

It will be noted that in normal operation of the communicating apparatuses EC and EC′, the radio communications are active, the throughput is known and generally the noise level of the useful radio bands (of frequencies) is known.

Obtaining a mapping cs1 or cs2 depends on the type of communication protocol used. For example, for a Wi-Fi communication, this obtaining may be carried out by scanning the spectrum of useful frequencies thanks to RSSI (Received Signal Strength Indication), or instead thanks to knowledge of the modulation and throughput (“get_RSSI” or “get_Rate” type functions or proprietary drive commands such as for example “wl rssi” in the case of the manufacturer Broadcom). For Wi-Fi, it is possible for example to consider that an inactive channel is polluted when its RSSI is above −90 dBm over 20 MHz. If the RSSI is above this value, this signifies that the noise is situated in the radio band and is going to reduce the signal to noise ratio. For example, the lower sensitivity in the case of the 802.11ac standard is equal to −82 dBm in MCSO at 20 MHz of pass band. Consequently, knowing that the PAPR (Peak-to-Average Power Ratio) is of the order of 10 dB, a noise at −90 dBm deteriorates the signal received.

In addition, most integrated circuits have internal tools making it possible to scan the radio environment (this is notably the case of the ACS tool for the manufacturer Broadcom, and the SCS tool for the manufacturer Quantenna). These tools can share in real time statistics on the occupation of a channel and also on the background noise thanks to a proprietary command (such as for example “acs_cli chanim” in the case of the manufacturer Broadcom).

For a LTE (Long Term Evolution) communication, the scanning of the spectrum may be done thanks to the RTWP (Received Total Wideband Power).

The detection of traffic may be done using functions distributed with the driver that manages the radio communication. In the case of a Wi-Fi communication, the distributed function may, for example and for the manufacturer Broadcom, be the statistic “Data (Mbps)” which is obtained using the command “wl bs_data”.

If no communication is active, it is possible to carry out a scanning over the useful radio band for measuring the RSSI on the radio channels.

Next in the step of the method, in the event of deterioration of the quality of radio communications resulting from the connection of the peripheral PE, there is modification of a first current operating configuration cf1 of the radio interface IR as a function of the determined mapping cs1 or a second current operating configuration cf2 of the physical interface IP.

In other words, thanks to the invention either the radio part (transmission/reception) of the communicating apparatus EC, or the physical interface IP part of the communicating apparatus EC, is going to be modified in order to be the least possible bothered by perturbations induced by the connection of the peripheral PE to this physical interface IP.

It will be understood that it is the processing means MT that are arranged to determine the modification having to be made to the first configuration cf1 and to trigger the carrying out of this modification.

For example, the modification of the first configuration cf1 may be chosen from at least one change of radio channel at the level of the radio interface IR and a change of radio band (of frequencies) at the level of the radio interface IR. To carry out one or the other change, it is necessary beforehand that the communicating apparatus EC negotiates it, at the request of the management device DG, with the other communicating apparatus EC′ with which it communicates via its radio interface IR.

When it is possible to carry out the two changes mentioned in the preceding paragraph, the processing means MT may, for example, begin by determining if the radio channel which is used by the radio interface IR (and which is perturbed) may be changed as a function of the determined mapping cs1. In this case, in the step of the method, in the event of impossibility of changing the radio channel used, the processing means MT may, for example, determine if it is possible to carry out a change of the radio band used as a function of the determined mapping cs1, and in the affirmative the processing means MT carry out this change of radio band.

In other words, if it is possible to change the radio channel (with regard to cs1) it is changed, otherwise an attempt is made to change the radio band used. And, if it is not possible either to change the radio band used (with regard to cs1), it is possible, for example, to determine a modification of the second configuration cf2 of the physical interface IP.

The determination of another radio channel available and less deteriorated may, for example, be done by controlling a tool such as ACS in the case of the manufacturer Broadcom, which is going to select in an autonomous manner the best available radio channel. In an alternative, it is possible, after having compared cs1 with cs2, to select the radio channel that has the best RSSI above a minimum required threshold (for example −90 dBm/20 Mhz), then to carry out a change of radio channel using a command such as “wl -i<interface> chanspec” which makes it possible to change radio channel on an integrated circuit of the manufacturer Broadcom.

To determine if the communicating apparatus EC′ can pass to another radio band, it is possible, for example, to use a technique such as band steering (a technology that detects if a communicating apparatus EC′ is compatible or not with a twin-band, and which, in the affirmative, pushes it to connect to the other radio band). To this end, it is possible to detect “probe requests” on each of the radio bands that can be used, and to deduce therefrom if the communicating apparatus EC′ is twin-band or not. For example, thanks to a function such as “send_event_to_sgc_wifiradio_socket( )” it is possible get back each event (or probe request) from the driver indicating on which band and for which MAC address the probe request has been received. This makes it necessary to maintain a list of twin-band communicating apparatuses EC′ that can support a change of radio band. If these communicating apparatuses EC′ support the 802.11v standard, it is possible, for example, to send them packets of “BSS Transition” type thanks to a command such as “wnm_bsstrans_req”, then it is possible to disconnect from the initial deteriorated radio band the communicating apparatuses EC′ thanks to a command such as “de-authenticate”. To avoid the communicating apparatuses EC′ returning to the initial deteriorated radio band, it is possible, for example, to place them in a “blacklist” associated with this initial deteriorated radio band. They are next removed from this blacklist once they are connected to the other radio band.

For example, the modification of the second configuration cf2 may be selected from at least a restraint of the physical interface IP and a deactivation of the physical interface IP. The restraint is for example intended to make the peripheral PE operate at a frequency that is different (for example lower) to its normal operating frequency, in order that it induces lesser perturbation.

Thus, in the case of a USB 3.0 key it is possible to restrain the physical interface IP in order that it only works in 2.0. For example, in a Linux type environment it is possible to force a USB 3.0 interface to operate in USB 2.0 using the command “setpci -H1 -d [<vendor>]:[<device>] d0.I=0”.

Using a hardware abstraction layer, the communicating apparatus EC can then change the operating configuration cf2 of its physical interface IP.

The deactivation of the physical interface IP, to which is connected the peripheral PE, has the consequence of eliminating the perturbation (or deterioration) induced by this peripheral PE. But obviously it temporarily prevents the use of the latter (PE).

For example, in a Linux type environment it is possible to deactivate a peripheral PE of USB key type by means of commands such as “echo disabled >/sys/bus/usb/devices/usb1/power/wakeup” and “echo suspend >/sys/bus/usb/devices/usb1/power/level”.

It will be noted that in the step of the method, in the presence of deterioration induced by the peripheral PE, of an impossibility of modifying the first configuration cf1 and of an operating priority of the radio interface IR compared to the physical interface IP, it is possible to begin by restraining this physical interface IP, and if this does not make it possible to improve the quality of radio communications it is possible to deactivate this physical interface IP.

In other words, if it is possible to restrain the physical interface IP it is restrained, otherwise this physical interface IP is deactivated. And, for example, if the peripheral PE is disconnected from the deactivated physical interface IP, it is next possible to reactivate said interface (IP) and to replace it in its second initial configuration cf2. To carry out this latter replacement it is possible, for example, to use commands such as “echo enabled >/sys/bus/usb/devices/usb1/power/wakeup” and “echo on >/sys/bus/usb/devices/usb1/power/level”.

It will be understood that it is the processing means MT that are arranged to trigger the restraint and/or the deactivation of the physical interface IP.

It will also be noted that an operating priority of the radio interface IR or of the physical interface IP may, for example, be chosen by a user of the communicating apparatus EC before the connection of the peripheral PE to the physical interface IP. To do so, if the communicating apparatus EC has a display screen and a control and selection human/machine interface, the user can select a sub-menu dedicated to management which is then displayed on the screen and in which the management device DG proposes it chooses either the operating priority of the radio interface IR or the operating priority of the physical interface IP.

Preferably, the user can at any moment change its prioritisation, for example in such a way as to make the peripheral PE priority on the radio communications, in order to use it.

FIG. 2 schematically illustrates an example of algorithm implementing a non-limiting example of management method according to the invention.

This algorithm comprises a preliminary sub-step 00 in which the analysis means MA determine the mapping cs2 of the quality of radio communications on the radio interface IR in the absence of peripheral PE connected to the physical interface IP.

The algorithm continues by a sub-step 10 in which the connection of the peripheral PE to the physical interface IP is detected. This detection may be carried out by the management device DG, or instead by the communicating apparatus EC which immediately informs the management device DG thereof. In this second alternative a notification may, for example, be sent to the middleware of the communicating apparatus EC via a proprietary communication bus and a “callback onAddDev( )” type function may then be called in the USB-SMU module. The USB-SMU module is a proprietary software module of the Sagemcom company which manages the USB/Sata ports of gateways. The USB-SMU module is thus a module for managing peripherals such as USB, SATA, etc.

The algorithm continues by a sub-step 20 in which the analysis means MA determine the mapping cs1 of the quality of radio communications on the radio interface IR in the presence of the peripheral PE connected to the physical interface IP.

Then, in a sub-step 30, the processing means MT carry out a test to determine if the detected connection has induced a notable deterioration of the quality of radio communications via the radio interface IR. This determination takes place by comparing the mapping cs1 determined in the sub-step 20 with the mapping cs2 determined in the preliminary sub-step 00.

In the absence of notable deterioration, the processing means MT decide, in a sub-step 40, not to act (that is to say not to carry out either a modification of the first configuration cf1 of the radio interface IR, or a modification of the second configuration cf2 of the physical interface IP).

On the other hand, in the presence of a notable deterioration, the processing means MT decide, in a sub-step 50, to act (that is to say carry out a modification of the first configuration cf1 of the radio interface IR or a modification of the second configuration cf2 of the physical interface IP).

FIG. 3 schematically illustrates an example of algorithm implementing an example of sub-step 50 of the management method according to the invention.

This algorithm comprises a sub-step 510 in which the processing means MT carry out a test to determine if the perturbed radio channel (used by the radio interface IR) may be changed, as a function of the mapping cs1 determined in the sub-step 20. In other words they determine in the mapping cs1 if another available and less perturbed (or deteriorated) radio channel exists for the interface IR.

In the affirmative (yes), the processing means MT determine in a sub-step 520 if this other radio channel may be accepted by the communicating apparatus EC′, and in the affirmative impose this other radio channel on the radio interface IR.

In the negative (no), the processing means MT carry out a test in a sub-step 530 to determine if the perturbed radio band (of frequencies) (used by the radio interface IR) may be changed, as a function of the mapping cs1 determined in the sub-step 20. In other words, they determine in the mapping cs1 if there exists another available and less perturbed (or deteriorated) radio band for the radio interface IR.

In the affirmative (yes), the processing means MT determine in a sub-step 540 if this other radio band may be accepted by the communicating apparatus EC′, and in the affirmative impose this other radio band on the interface IR.

In the negative (no), the processing means MT carry out a test in a sub-step 550 to determine if a radio priority has been chosen beforehand (for example by the user of the communicating apparatus EC).

In the negative (no), this signifies that the user considers that it is the use of the physical interface IP (and thus of the peripheral PE) that is priority, and consequently, in a sub-step 560 the processing means MT decide not to act.

In the affirmative (yes), the processing means MT carry out a test in a sub-step 570 to determine if it is possible to restrain the physical interface IP in order to reduce (or even eliminate) the deterioration induced by the peripheral PE and thereby to improve the quality of radio communications.

In the affirmative (yes), the processing means MT impose this restraint on the physical interface IP in a sub-step 580, then pass to a sub-step 610 described hereafter.

In the negative (no), the processing means MT carry out a test in a sub-step 590 to determine if the physical interface IP has been deactivated.

In the affirmative (yes), the processing means MT consider that there is nothing to do and thus in a sub-step 560 decide not to act.

In the negative (no), the processing means MT deactivate the physical interface IP in a sub-step 600 since it is not priority for the user. Then, in a sub-step 610 the processing means MT carry out a test to determine if the peripheral PE has been disconnected from the physical interface IP by the user.

In the affirmative (yes), the processing means MT consider in a sub-step 620 that in the absence of peripheral PE radio communications via the radio interface IR are no longer deteriorated, and thus reactivate the physical interface IP and replace it in its second initial configuration cf2.

In the negative (no), the processing means MT again carry out the sub-step 510.

It will be noted that the invention may also be considered in the form of a computer programme product comprising a set of instructions which, when it is executed by processing means (for example of processer or CPE type) of a communicating apparatus EC, is suitable for implementing a management method of the type of that described here above for managing at least one radio interface IR and at least one physical interface IP of this communicating apparatus EC.

The invention is not limited to the embodiments of management method, management device and communicating apparatus described above, only as examples, but it encompasses all the alternatives that those skilled in the art could envisage within the sole framework of the claims hereafter.

1. A method for managing at least one radio interface and at least one physical interface of a communicating apparatus, comprising:
in the event of connection of a peripheral to said physical interface, determining a mapping of a quality of radio communications on said radio interface,
comparing the determined mapping with another mapping of the quality of radio communications on said radio interface in the absence of peripheral connected to said physical interface, and
in the event of deterioration of said quality of radio communications resulting from said connection, modifying a first current operating configuration of said radio interface as a function of said determined mapping or a second current operating configuration of said physical interface.

2. The method according to claim 1, wherein said modification of the first configuration is chosen from a group comprising a change of radio channel and a change of radio band.

3. The method according to claim 2, further comprising, in the event of impossibility of changing a radio channel used, determining if it is possible to carry out a change of a radio band used, and in the affirmative the change of radio band is carried out.

4. The method according to claim 1, wherein said modification of the second configuration is chosen from a group comprising a restraint of said physical interface and a deactivation of said physical interface.

5. The method according to claim 4, further comprising, in the presence of said deterioration, of an impossibility of modifying said first configuration and of an operating priority of said radio interface, restraining said physical interface, and if this does not make it possible to improve said quality of radio communications said physical interface is deactivated.

6. The method according to claim 1, further comprising choosing an operating priority of said radio interface or of said physical interface by a user of said communicating apparatus before said connection of the peripheral to said physical interface.

7. The method according to claim 1, further comprising before said determining, determining said mapping of the quality of radio communications on said radio interface in the absence of peripheral connected to said physical interface.

8. A non-transitory computer readable medium comprising a set of instructions which, when it is executed by a processor, is suitable for implementing the method according to claim 1 for managing at least one radio interface and at least one physical interface of a communicating apparatus.

9. A device for managing at least one radio interface and at least one physical interface of a communicating apparatus, comprising an analysing system adapted to, in the event of connection of a peripheral to said physical interface, determine a mapping of the quality of radio communications on said radio interface, and a processor configured to compare the mapping with another mapping of the quality of radio communications on said radio interface in the absence of peripheral connected to said physical interface, and, in the event of deterioration of said quality of radio communications resulting from said connection, to trigger a modification of a first current operating configuration of said radio interface as a function of said determined mapping or a second current operating configuration of said physical interface.

10. Communicating apparatus comprising at least one radio interface, at least one physical interface, and a management device according to claim 9.
